(19) United States
(12) Patent Application Publication
(10) Pub. No.: US 2026/0162494 A1
(43) Pub. Date: Jun. 11, 2026

(54) SYSTEM AND METHOD FOR CELEBRITY-INTEGRATED AND SOCIALLY-ENHANCED ONLINE POKER PLATFORM

(71) Applicant: Benjamin Geza Affleck-Boldt, West Hollywood, CA (US)

(72) Inventor: Benjamin Geza Affleck-Boldt, West Hollywood, CA (US)

(21) Appl. No.: 19/381,204

(22) Filed: Nov. 6, 2025

Related U.S. Application Data
(60) Provisional application No. 63/729,810, filed on Dec. 9, 2024.

(51) Int. Cl. G07F 17/32

(52) U.S. Cl. CPC G07F 17/3241; G07F 17/3237; G07F 17/3293

(57) ABSTRACT

Systems and methods for generating content prediction data for accurate content retrieval. Such a method includes (i) receiving a suspended player list; (ii) receiving at least one of an audio data set or a visual data set; (iii) detecting, by using a trained machine learning model to process a plurality of event packet streams from the plurality of user profiles, one or more anomalies in event traffic originating from at least one user; (iv) determining a likelihood that the one or more anomalies are associated with one or more malicious event packets from the at least one user profile; (v) appending the at least one user profile to the suspended player list based on (a) the likelihood and (b) the at least one of the audio data set or the visual data set; and (vi) blocking the at least one user profile from participating in future hands of play.

### CROSS REFERENCE TO RELATED APPLICATIONS

This application claims the benefit of U.S. Provisional Ser. No. 63/729,810, entitled “SYSTEM AND METHOD FOR CELEBRITY-INTEGRATED AND SOCIALLY-ENHANCED ONLINE POKER PLATFORM,” filed Dec. 9, 2024. U.S. Provisional Ser. No. 63/729,810 is hereby expressly incorporated by reference herein in its entirety.

### FIELD OF TECHNOLOGY

The present disclosure relates to presenting a secure game platform to users and, more specifically, to techniques for detecting and analyzing potential use of third party software or other such cheating techniques to provide a secure and trusted environment to users.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

Online game systems, such as for poker, blackjack, roulette, chess, and/or other such games provide an environment for players to compete and play with others at almost any time or place. However, by competing in a purely online environment, a number of security and privacy concerns arise that do not exist in a more conventional setting. For example, the introduction of an online environment introduces additional risk of the use of third party programs (e.g., to track cards, to read opponent cards or decisions, etc.) or vulnerabilities in the system to enable some players to gain an advantage over others.

Further, the lack of familiarity many users have with computing and programming techniques erode trust of users in the platforms in question, leading to fear regarding cheating, unfair techniques, and predatory practices by other players. Traditional approaches to such may rely entirely on backend detection, which may be vulnerable to more subtle applications and similarly may do little to assuage security concerns from users. Moreover, traditional game systems lack a social aspect otherwise present in real world settings, such as casinos.

As such, it is desirable to create a system that provides more secure detection of unwanted activity, improves trust in the overall game platform, and provides an improved social experience to users.

### SUMMARY

In some aspects, the techniques described herein relate to a computer-implemented method for using a trained machine learning model to detect malicious event packets in a game-focused environment, including: receiving, by one or more processors, a suspended player list including a set of identifiers each corresponding to a respective suspended player profile; receiving, by the one or more processors, at least one of an audio data set or a visual data set corresponding to a plurality of user profiles of the game-focused environment; detecting, by the one or more processors and by using a trained machine learning model to process a plurality of event packet streams from the plurality of user profiles, one or more anomalies in event traffic originating from at least one user profile of the plurality of user profiles; determining, by the one or more processors, a likelihood that the one or more anomalies are associated with one or more malicious event packets from the at least one user profile; in response to the likelihood meeting or exceeding a threshold, appending, by the one or more processors, the at least one user profile to the suspended player list to generate an updated suspended player list based on (i) the likelihood and (ii) the at least one of the audio data set or the visual data set; and blocking, by the one or more processors, the at least one user profile from participating in future hands of play for the game-focused environment based on the updated suspended player list.

In some aspects, the techniques described herein relate to a computer-implemented method, wherein the one or more anomalies in event traffic occur during a hand of play.

In some aspects, the techniques described herein relate to a computer-implemented method, wherein the at least one of the audio data set or the visual data set corresponds to a moderator user profile, and the at least one of the audio data set or the visual data set includes an indication from the moderator user profile that the at least one user profile is associated with a corresponding suspended player profile on the suspended player list.

In some aspects, the techniques described herein relate to a computer-implemented method, wherein the at least one user profile includes a first user profile, and the appending the at least one user profile to the suspended player list includes: determining, by the one or more processors, that at least one of a first audio data set or a first visual data set of the at least one of the audio data set or the visual data set meets or exceeds a similarity threshold with a second audio data set or a second visual data set associated with a second user profile; and appending, by the one or more processors, the first user profile and the second user profile to the suspended player list.

In some aspects, the techniques described herein relate to a computer-implemented method, wherein the at least one user profile includes a first user profile, and the appending the at least one user profile to the suspended player list includes: determining, by the one or more processors, that at least one of a first audio data set or a first visual data set of the at least one of the audio data set or the visual data set meets or exceeds a similarity threshold with a second audio data set or a second visual data set associated with a corresponding suspended player profile on the suspended player list.

In some aspects, the techniques described herein relate to a computer-implemented method, further including: transmitting, by the one or more processors, the at least one of the first audio data set or the first video data set to a verification device; and receiving, by the one or more processors, a confirmation that the at least one of the first audio data set or the first video data set is similar to the second audio data set or the second visual data set; wherein the blocking is responsive to the receiving of the confirmation.

In some aspects, the techniques described herein relate to a computer-implemented method, wherein the appending includes: receiving, by the one or more processors, first financial account data associated with the first user profile and second financial account data associated with the corresponding suspended player profile; and determining, by the one or more processors, that the first financial account data matches the second financial account data.

In some aspects, the techniques described herein relate to a system configured for using a trained machine learning model to detect malicious event packets in a game-focused environment, including: a memory storing a set of computer-executable instructions; and one or more processors interfacing with the memory, and configured to execute the computer-executable instructions to cause the one or more processors to: receive a suspended player list including a set of identifiers each corresponding to a respective suspended player profile; receive at least one of an audio data set or a visual data set corresponding to a plurality of user profiles of the game-focused environment; detect, by using a trained machine learning model to process a plurality of event packet streams from the plurality of user profiles, one or more anomalies in event traffic originating from at least one user profile of the plurality of user profiles; determine a likelihood that the one or more anomalies are associated with one or more malicious event packets from the at least one user profile; in response to the likelihood meeting or exceeding a threshold, append the at least one user profile to the suspended player list to generate an updated suspended player list based on (i) the likelihood and (ii) the at least one of the audio data set or the visual data set; and block the at least one user profile from participating in future hands of play for the game-focused environment based on the updated suspended player list.

In some aspects, the techniques described herein relate to a system, wherein the one or more anomalies in event traffic occur during a hand of play.

In some aspects, the techniques described herein relate to a system, wherein the at least one of the audio data set or the visual data set corresponds to a moderator user profile, and the at least one of the audio data set or the visual data set includes an indication from the moderator user profile that the at least one user profile is associated with a corresponding suspended player profile on the suspended player list.

In some aspects, the techniques described herein relate to a system, wherein the at least one user profile includes a first user profile, and appending the at least one user profile to the suspended player list includes: determining that at least one of a first audio data set or a first visual data set of the at least one of the audio data set or the visual data set meets or exceeds a similarity threshold with a second audio data set or a second visual data set associated with a second user profile; and appending the first user profile and the second user profile to the suspended player list.

In some aspects, the techniques described herein relate to a system, wherein the at least one user profile includes a first user profile, and appending the at least one user profile to the suspended player list includes: determining that at least one of a first audio data set or a first visual data set of the at least one of the audio data set or the visual data set meets or exceeds a similarity threshold with a second audio data set or a second visual data set associated with a corresponding suspended player profile on the suspended player list.

In some aspects, the techniques described herein relate to a system, wherein the memory further stores instructions that, when executed by the one or more processors, cause the system to: transmit the at least one of the first audio data set or the first video data set to a verification device; and receive a confirmation that the at least one of the first audio data set or the first video data set is similar to the second audio data set or the second visual data set; wherein blocking the at least one user profile is responsive to the receiving of the confirmation.

In some aspects, the techniques described herein relate to a system, wherein appending the at least one user profile to the suspended player list includes: receiving first financial account data associated with the first user profile and second financial account data associated with the corresponding suspended player profile; and determining that the first financial account data matches the second financial account data.

In some aspects, the techniques described herein relate to a tangible, non-transitory computer-readable medium storing instructions for using a trained machine learning model to detect malicious event packets in a game-focused environment that, when executed by one or more processors of a computing device, cause the computing device to: receive a suspended player list including a set of identifiers each corresponding to a respective suspended player profile; receive at least one of an audio data set or a visual data set corresponding to a plurality of user profiles of the game-focused environment; detect, by using a trained machine learning model to process a plurality of event packet streams from the plurality of user profiles, one or more anomalies in event traffic originating from at least one user profile of the plurality of user profiles; determine a likelihood that the one or more anomalies are associated with one or more malicious event packets from the at least one user profile; in response to the likelihood meeting or exceeding a threshold, append the at least one user profile to the suspended player list to generate an updated suspended player list based on (i) the likelihood and (ii) the at least one of the audio data set or the visual data set; and block the at least one user profile from participating in future hands of play for the game-focused environment based on the updated suspended player list.

In some aspects, the techniques described herein relate to a tangible, non-transitory computer-readable medium, wherein the one or more anomalies in event traffic occur during a hand of play.

In some aspects, the techniques described herein relate to a tangible, non-transitory computer-readable medium, wherein the at least one of the audio data set or the visual data set corresponds to a moderator user profile, and the at least one of the audio data set or the visual data set includes an indication from the moderator user profile that the at least one user profile is associated with a corresponding suspended player profile on the suspended player list.

In some aspects, the techniques described herein relate to a tangible, non-transitory computer-readable medium, wherein the at least one user profile includes a first user profile, and appending the at least one user profile to the suspended player list includes: determining that at least one of a first audio data set or a first visual data set of the at least one of the audio data set or the visual data set meets or exceeds a similarity threshold with a second audio data set or a second visual data set associated with a second user profile; and appending the first user profile and the second user profile to the suspended player list.

In some aspects, the techniques described herein relate to a tangible, non-transitory computer-readable medium, wherein the at least one user profile includes a first user profile, and appending the at least one user profile to the suspended player list includes: determining that at least one of a first audio data set or a first visual data set of the at least one of the audio data set or the visual data set meets or exceeds a similarity threshold with a second audio data set or a second visual data set associated with a corresponding suspended player profile on the suspended player list.

In some aspects, the techniques described herein relate to a tangible, non-transitory computer-readable medium, wherein the non-transitory computer-readable medium further includes instructions that, when executed by the one or more processors, cause the computing device to: transmit the at least one of the first audio data set or the first video data set to a verification device; and receive a confirmation that the at least one of the first audio data set or the first video data set is similar to the second audio data set or the second visual data set; wherein blocking the at least one user profile is responsive to the receiving of the confirmation.

### BRIEF DESCRIPTION OF THE DRAWINGS

FIG. 1 is a block diagram of an example system in which techniques of the present disclosure can be implemented.

FIG. 2A depicts an example game-focused environment that may be implemented in the system of FIG. 1.

FIG. 2B depicts an example game-focused environment including a security window that may be implemented in the system of FIG. 1.

FIG. 3 is a flow diagram of an example method for detecting malicious activity by one or more users and appending the corresponding users to a suspended player list, implemented in the system of FIG. 1.

### DETAILED DESCRIPTION OF THE DRAWINGS

In the following description, specific details are set forth describing some examples consistent with the present disclosure. Numerous specific details are set forth in order to provide a thorough understanding of the examples. It will be apparent, however, to one skilled in the art that some examples may be practiced without some or all of these specific details. The specific examples disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one example may be incorporated into other examples unless specifically described otherwise or if the one or more features would make an example non-functional. In some instances, well known methods, procedures, components, and circuits have not been described in detail so as not to unnecessarily obscure aspects of the examples.

As detailed herein, online game systems, such as for poker, blackjack, roulette, chess, and/or other such games, provide an environment for players to compete and play with others at almost any time or place. However, the introduction of semi-anonymous to completely anonymous players in an online environment prevents or reduces the effectiveness of traditional security measures, and thereby introduces additional problems for games in an online environment that may not be extant in a real-world environment. For example, third party software may introduce tools that a malicious user can utilize to cheat at games within the online environment, whether directly (e.g., by modifying game elements) or indirectly (e.g., by enabling the malicious user to utilize techniques or data not available to humans in a traditional setting). While direct methods of cheating may be able to be detected through the inherent interaction with and/or modification of elements in the online environment, indirect methods may be difficult to distinguish using more traditional, backend cheating detection techniques. Further, the lack of familiarity users may have with computing techniques may erode user trust in the online platform, leading to fear regarding malicious players.

By introducing a trusted player profile, however, a trusted vector is introduced both to utilize for security purposes as well as to address user concerns associated with actions taken to prevent malicious play. For example, introducing a trusted profile such as celebrity user profiles (also referred to herein as a VIP profile) and/or moderator profiles, an additional security node may be introduced by utilizing data provided by the trusted profile, such as video data, audio data, etc. Additionally, a trusted user profile opting in to share video data and/or audio data with other users (e.g., a video stream captured by a webcam used by the trusted user) may encourage other users participating in the online game environment to similarly opt in, enabling a more social and more secure environment for participating in an online game, as discussed in more detail herein.

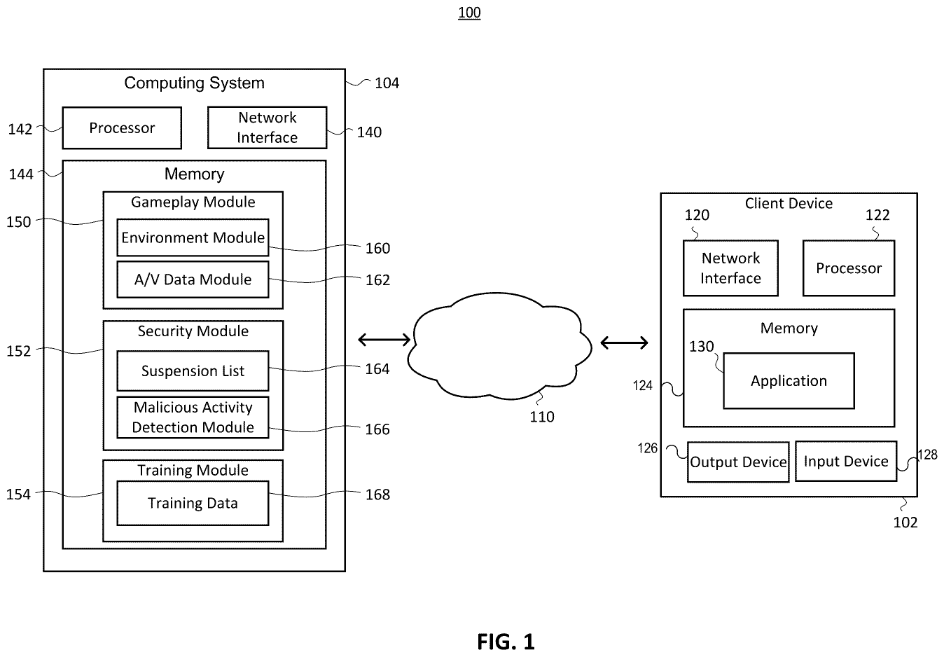

FIG. 1 illustrates an example system 100 in which the techniques disclosed herein may be implemented. The example system 100 includes a client device 102, a computing system 104, and a network 110. The computing system 104 in some implementations is remote from and communicatively coupled to the client device 102 via the network 110. It will be understood that system 100 is exemplary, and that other systems may include additional, fewer, or alternative components (e.g., training module 154 may be omitted, or a visualization module (not depicted) may be included). Similarly, arrangements of the components of system 100 may be modified. For example, some elements of system 100 may be combined, split apart, swapped, etc.

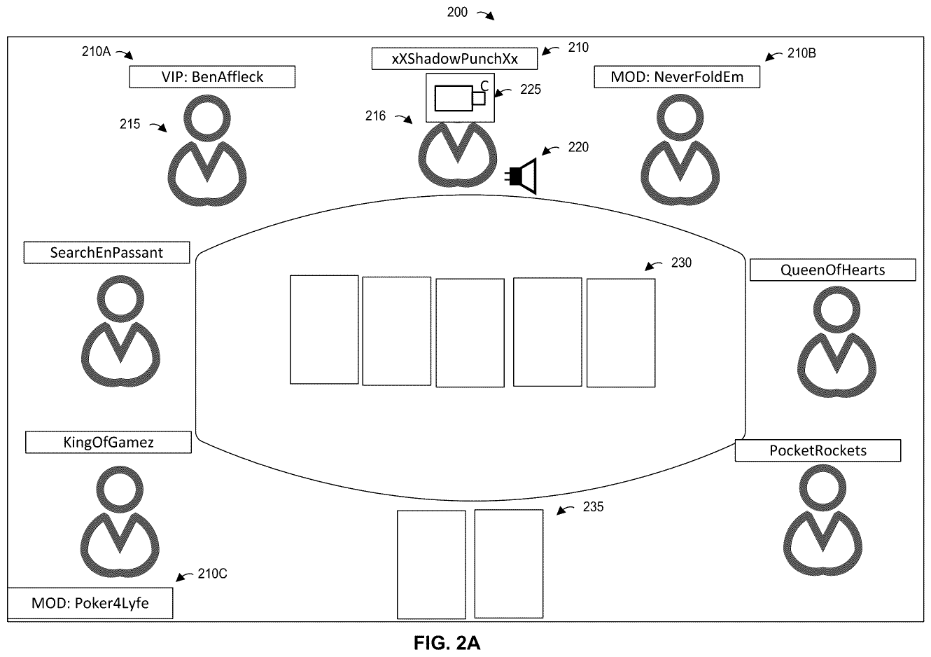

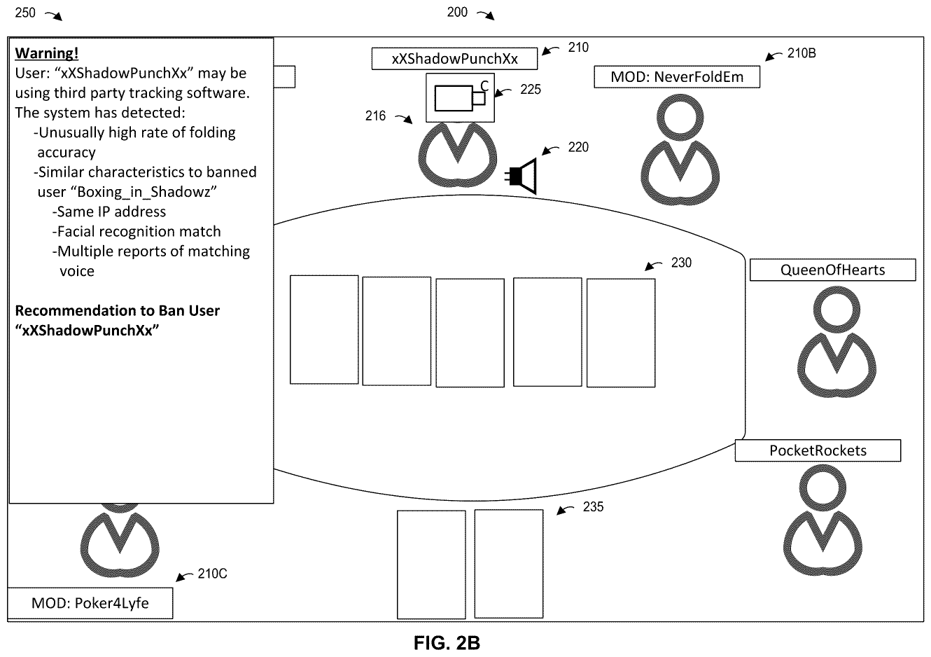

The client device 102 may be configured to access an application 130 that allows access to a gameplay environment (e.g., as described below with regard to FIGS. 2A and 2B) via a network interface 120. The computing system 104 may interact with the client device 102 (e.g., via the network interface 140 and network interface 120, respectively) to provide assets of and/or access to the gameplay environment.

The client device 102 may be or include any stationary, mobile, or portable computing device with wired and/or wireless communication capability (e.g., a smartphone, a tablet computer, a laptop computer, a desktop computer, a smart wearable device such as smart glasses or a smart watch, etc.). In the example implementation of FIG. 1, the client device 102 includes a network interface 120, a processor 122, memory 124, an output device 126, and an input device 128.

The network interface 120 may include hardware, firmware, and/or software configured to enable the client device 102 to exchange electronic data with the computing system 104 via the network 110. For example, the network interface 120 may include a cellular communication transceiver, a Wi-Fi transceiver, and/or transceivers for one or more other wired and/or wireless communication technologies.

The processor 122 may be a single processor (e.g., a central processing unit (CPU)), or may include a set of processors (e.g., multiple CPUs, or one or more CPUs and one or more graphics processing units (GPUs), one or more cores, etc.).

The memory 124 includes one or more computer-readable, non-transitory storage units or devices, each of which may respectively include one or more persistent (e.g., hard disk) and/or non-persistent (e.g., random-access memory) memory components. The memory 124 stores instructions that are executable by the processor 122 to perform various operations, including the instructions of various software applications and the data generated and/or used by such applications. In the example implementation of FIG. 1, the memory 124 stores at least an application 130, which may be, for example, a web browser application, a mobile application downloaded from an application store, a streaming application configured to allow access to an application downloaded on another device (not shown), etc.

Application 130 may be executed by processor 122 to present a rendered gameplay environment and/or elements of such to the user of the client device 102 via the output device 126 (e.g., including a display and/or one or more speakers of the client device 102). In implementations in which the application 130 is a web browser application, for instance, the client device 102 may present the rendered gameplay environment via a web page hosted by a publisher or a content provider, with the web browser causing the client device 102 to download Hypertext Markup Language (HTML), scripts, and/or other code of the web page for presentation to a user via the output device 126.

The output device 126 includes hardware, firmware, and/or software configured to enable a user to view visual outputs of the client device 102, hear audio outputs of the client device 102, etc. Depending on the implementation, the output device 126 may include a display using any suitable display technology (e.g., LED, OLED, LCD, etc.). In some implementations, the output device 126 includes a visual output incorporated in a touchscreen having both display and manual input capabilities. Moreover, in some implementations where the client device 102 is a wearable device, the output device 126 includes a transparent viewing component (e.g., lenses of smart glasses) with integrated electronic components. For example, the output device 126 may include micro-LED or OLED electronics embedded in lenses of smart glasses. In further implementations, the output device 126 includes or is an audio output device, such as a speaker, headphones, a text-to-talk device, etc.

The input device 128 may include audio and/or video inputs. For example, the input device 128 may include a webcam or other video recording device, a microphone or other audio recording device, etc. Similarly, the input device 128 may additionally or alternatively include methods for inputting commands to the application 130 (e.g., a keyboard, a controller, a mouse, a voice-command system, etc.).

While FIG. 1 shows client device 102 as a single component communicating directly (i.e., via network 110) with the computing system 104, in some implementations the subcomponents of client device 102 shown in FIG. 1 are instead divided among two or more user-side devices. For example, the client device 102 may be or include a device accessing the application 130 stored at another user-side device (e.g., via a streaming application, a remote access application, etc.). As another example, a pair of smart glasses may include the processor 122, the memory 124, and the output device 126, while a smartphone may include another processing unit, another memory, another output, and the network interface 120. The smart glasses (or smart helmet, etc.) may then communicate as needed with the smartphone (e.g., via Bluetooth) to enable the operations described herein.

The computing system 104 includes a network interface 140, a processor 142, and memory 144. The network interface 140 includes hardware, firmware, and/or software configured to enable the computing system 104 to exchange electronic data with the client device 102 and other, similar client devices via the network 110. For example, the network interface 140 may include a wired or wireless router and a modem. The processor 142 may be a single processor, may include two or more processors, etc. The computing system 104 may include one or more servers, for example, which may reside at a single location or multiple locations.

The memory 144 is a computer-readable, non-transitory storage unit or device, or collection of units/devices that may include persistent and/or non-persistent memory components. The memory 144 stores the instructions of a gameplay module 150, a security module 152, and a training module 154, each of which may be executed by the processor 142. In the example system 100, the gameplay module 150 includes (or remotely accesses) an environment module 160 and an audio/visual (A/V) data module 162. The security module 152 includes (or remotely accesses) a suspension list 164 and malicious activity detection module 166. The training module 154 uses training data 168 to train one or more machine learning models (e.g., used by and/or included in the malicious activity detection module 166, the A/V data module 162, etc.). In some implementations, some of the software modules/units shown in FIG. 1 are omitted. For example, the computing system 104 may omit training module 154 (e.g., if the training is done by a different computing system).

The gameplay module 150, security module 152, and training module 154 may be software modules comprising instructions executed by the processor 142 to perform the various operations described herein. It is understood, however, that other architectures are also possible (e.g., with functionality of modules 150 and 152 being provided by a single software module, or with functionality of module 150 being split among a plurality of software modules, and so on).

Generally, the gameplay module 150 uses an environment module 160 in to generate an environment (e.g., environment 200 of FIGS. 2A and 2B below) to facilitate gameplay for one or more users. Depending on the implementation, the environment may include a plurality of rendered elements for facilitating play of the corresponding game, as described in more detail with regard to FIGS. 2A and 2B below.

In some implementations, a user may generate a private environment and/or round within an environment (e.g., with custom rules). For example, users may generate a personalized game room with chosen rules, stakes, participants, etc. Similarly, players may, by custom rules, use or refrain from using a timer and/or other such metrics for modifying overall gameplay.

The environment module 160 may function in conjunction with the A/V module 162 to stream video and/or audio data for the user to other users, reducing anonymity and improving overall security and trust. Similarly, the environment module 160 may render, store, etc. a player friend list, player profile information, and/or an in-game chat system through which players and/or observers may chat and/or react.

In some implementations, the A/V module 162 retrieves, transmits, and/or analyzes audio and/or visual data for one or more users. For example, the client device 102 may capture audio and/or video data (also referred to as “A/V data”) (e.g., via the input device 128) and transmit the captured A/V to the computing system 104. The computing system 104 may, when called by the security module 152, analyze the A/V data and/or compare the gathered and/or current A/V data to stored and/or historical A/V data. In some such implementations, the computing system 104 uses a trained machine learning model to compare and/or otherwise analyze the A/V data to determine whether a detected similarity between the sets of A/V data meets or exceeds a similarity threshold.

In some implementations, the security module 152 uses the malicious activity detection module 166 in conjunction with a stored suspension list 164 to detect and block users and/or network data packets from users breaking rules against use of tracking software, cheating software, third party tools, etc. In some implementations, the security module 152 uses a trained machine learning model (e.g., as described herein) to detect the use of cheating software, tracking software, and/or other such third party tools. In further implementations, the security module 152 uses A/V data (e.g., gathered and/or stored by the A/V data module 162 as described above). In some implementations, the security module 152 uses A/V data associated with the user being considered for addition to the suspended player list. In further implementations, the security module 152 uses A/V data associated with a trusted player profile (e.g., a moderator profile, a VIP profile, etc.) to determine for comparison and/or analysis. In still further implementations, the security module 152 uses impressions of the A/V data for the determination, such as by querying trusted players (e.g., a moderator, a VIP, etc.) to determine impressions of the A/V data by the trusted players (e.g., whether the behavior matched a previously suspended player, whether the voice/face matched a previously suspended player, etc.). In yet still further implementations, the security module 152 uses additional information (e.g., financial information, IP address information, etc.) to determine whether to suspend a player profile.

In some implementations and/or scenarios, the computing system 104 (or another computing system not shown in FIG. 1) trains one or more models used by the gameplay module 150 and/or the security module 152 (e.g., the A/V data module 162, malicious activity detection module 166). In particular, the training module 154 may train the modules using training data 168 as described herein. In some implementations, the training data 168 includes data associated with known cheating software, tracking software, third-party tools, etc. (collectively referred to as “malicious software”). For example, the training data 168 may include one or more identifiers for known malicious software, logs of access by known malicious software, logs of commands generated by known malicious software, etc. Similarly, the training data 168 may include data collated data associated with malicious software to train a malicious activity detection module 166 to predict future malicious software use and/or detect unknown malicious software use. In further implementations, the training data 168 is used to train a model used by the A/V data module 162 (e.g., to analyze audio and/or visual data) and includes historical audio data, historical visual data, etc. In still further implementations, the training data 168 is used to train a model used as part of the gameplay (e.g., a model to function as an artificial player (e.g., a “dealer” player in a blackjack game, another player in a poker game, an “assistant” player in a game to assist a player to learn, etc.)). In such implementations, the training data 168 includes historical data related to a corresponding type of player, one or more guidelines or rules, etc. Depending on the implementation, one or more models used by the computing system 104 may be or include a chatbot or large language model (LLM), and the training data 168 may therefore include language data used to train the model(s).

In some implementations, training module 154 is included in a computing system other than computing system 104, and computing system 104 only includes or accesses the models and/or modules in question after the model(s)/module(s) is/are trained. In some implementations, training machine learning models may produce byproduct weights, or parameters which may be initialized to random values. The weights may be modified as the network is iteratively trained to cause the values output by the network to converge to expected (or “learned”) values.

In some implementations, as noted above, the modules and/or models (e.g., the gameplay module 150, the content retrieval model 164, and/or the auction model 166) may be or include an LLM, a generative AI model, etc., and may have been trained by computing system 104 or another computing system using supervised or semi-supervised learning techniques, using training data of the appropriate modality (e.g., text data). Such models may be general-purpose models (e.g., trained on a wide array of publicly available datasets such as web pages, documents, etc., available via the Internet) or may be a domain-specific model (e.g., trained or finetuned on custom and/or proprietary datasets, such as documents/data available via one or more intranets). In some implementations, the models have parameters tuned, via the training process, specifically for high performance in a corresponding context.

The operation of the gameplay module 150, the security module 152, the training module 154, and their constituent parts, will be discussed in further detail below in connection with various example implementations.

In some implementations, users hold accounts associated with the gameplay environment provided by the computing system 104. In these implementations, information associated with the accounts may be stored in an account database (not shown in FIG. 1) and/or an account module (not shown in FIG. 1) stored at the computing system 104. The account database and/or account module may be stored in the memory 144 or may be stored in one or more memories that are remote from the computing system 104, for example. The account information may include information such as account name, user name, subscription level, saved audio data, saved visual data, saved payment and/or financial account data, saved gameplay data, and so on.

The network 110 may be a single communication network (e.g., the Internet), and in some implementations also includes one or more additional networks. As an example, the network 110 may include a cellular network, the Internet, and/or a server-side local area network (LAN). While FIG. 1 shows only a single client device 102 and computing system 104, it will be understood that the system 100 may include any suitable number of similar client devices, server devices, and/or other such computing devices operating according to the principles disclosed herein.

FIGS. 2A and 2B depict exemplary environment 200 that may be generated by gameplay module 150, displayed and/or rendered by client device 102, and/or analyzed by security module 152, for example. It is understood, however, that these are just some of a number of potential configurations and/or uses for the environment 200.

FIG. 2A depicts the exemplary environment 200 (e.g., also referred to as a “game-focused environment”) for poker. It will be understood that, although the environment 200 is described with respect to poker, such is exemplary only. For example, the gameplay-focused environment 200 may be for and/or include additional or alternate games, such as blackjack, craps, pinochle, war, bridge, canasta, gin rummy, speed, cheat, baccarat cribbage, nine men's morris, chess, checkers, go, shogi, mahjong, mancala, four-in-a-row, hit and blow, dominoes, backgammon, president, roulette, and/or any other such game. The gameplay-focused environment may therefore include various gameplay elements for a corresponding game. Depending on the implementation, the gameplay elements may include common gameplay elements 230 (e.g., gameplay elements common and/or visible to multiple or all of the players participating in a hand or round of the game within the gameplay environment 200) and personal gameplay elements 235 (e.g., gameplay elements associated with and/or visible only to a particular user participating in a hand or round of the game within the gameplay environment 200).

For example, in the exemplary embodiment of FIG. 2A, the common gameplay elements 230 include multiple cards that apply to the hands held by each player (e.g., the flop, the turn, and the river). In such an example, the common gameplay elements are fully visible to all players. Similarly, in the exemplary embodiment of FIG. 2A, the personal gameplay elements 235 include cards held in the hand of the user (e.g., hand cards, pocket cards, hole cards, etc.) that are only visible to the corresponding player. In some embodiments, the client device 102 rendering the environment 200 may additionally render obscured versions of the personal gameplay elements 235 (e.g., cards with only the back visible, etc.) so that information inherent in the personal gameplay elements 235 are shown only to the corresponding user. In other games and/or game modes, the gameplay environment may include other elements as part of the common gameplay elements 230 (e.g., a board, common pieces, a roulette wheel, a deck, etc.) and/or personal gameplay elements 235 (e.g., pieces programmed to only be interactable with for a particular user, chips, particular tiles, etc.).

In some implementations, the environment 200 additionally includes a number of avatars 215 and usernames 210 associated with and/or otherwise representative of players in the environment 200. Depending on the implementation, the avatars 215 and/or usernames 210 may be chosen by a user associated with a corresponding account (e.g., at account creation, outside of a round or hand in the game-focused environment 200, etc.). In some implementations, the avatar 215 may include an image and/or other visually identifiable element chosen by the corresponding user (e.g., a profile picture, a customizable face, one or more customizable objects, etc.). In further implementations, the avatar 215 may include video data 225 associated with a user. For example, in the exemplary embodiments of FIG. 2A, the avatar 216 includes a video feed replacing the face of the avatar 216 (e.g., video stream data of the user in question). In further implementations, the embodiment may display the video data 225 separately from the avatar 216. Similarly, the environment 200 may display and/or otherwise include an icon 220 indicating whether audio data is being recorded and/or projected for the corresponding user.

In the context of the disclosed system and method for a celebrity-integrated and socially-enhanced online poker platform, the environment 200 may be generated by the computing system 104 to facilitate gameplay for one or more users. The environment 200 may include a plurality of rendered elements designed to enhance the gaming experience, such as avatars 215, usernames 210, and various gameplay elements that may be common to all players or specific to individual players.

A round, or hand, within the environment 200, may be conceptualized as an object that is generated by the computing system 104. This object may be part of a session object that encompasses the entirety of a gameplay session within the environment 200. Each round or hand object may be associated with one or more user profiles, indicating the participants in that specific round or hand of play. The association between a round or hand object and user profiles allows for the tracking of gameplay actions, decisions, and outcomes specific to each user within the context of the round or hand.

The user profiles associated with a round or hand may include various types of data, such as player statistics, historical gameplay data, and preferences. This association enables the computing system 104 to tailor the gameplay experience to the individual users, potentially enhancing engagement and satisfaction. Furthermore, the user profiles may be linked to broader social features within the environment 200, such as friend lists, chat systems, and social media integrations, thereby enriching the social aspect of the online poker platform.

The generation of a round or hand object by the computing system 104 may involve several steps, including the initialization of the object with default settings, the assignment of participating user profiles, and the configuration of gameplay parameters based on the session object's settings and the associated user profiles'preferences. Throughout the gameplay session, the computing system 104 may update the round or hand object to reflect the current state of play, including the actions taken by users, the progression of the game, and any outcomes or results.

Event streams, in relation to round or hand objects within the environment 200, may be understood as sequences of data points or messages that are generated as a result of user actions and system responses during a round or hand of play. These event streams enable the dynamic operation of the environment 200, as they facilitate communication and interaction between the computing system 104 and the client devices 102 of the users participating in a game.

Each event in an event stream may correspond to a specific action taken by a user, such as placing a bet, folding, or revealing cards, or to a system-generated event, such as the dealing of cards or the announcement of a winner at the end of a round. These events are captured and transmitted as part of the event stream, enabling the computing system 104 to process and respond to user actions in a timely manner. The event streams are associated with the round or hand objects, ensuring that the flow of events is contextualized within the specific gameplay session.

The computing system 104 may process these event streams using a trained machine learning model, as described herein. This processing may involve detecting anomalies or patterns in the event traffic that could indicate the presence of malicious activity or the use of unauthorized third-party software. By analyzing the event streams in the context of the round or hand objects to which they belong, the computing system 104 can maintain the integrity and fairness of the gameplay environment.

Furthermore, the association of event streams with round or hand objects allows for a detailed historical record of gameplay actions and outcomes. This record can be used for various purposes, such as auditing game fairness, analyzing player behavior, and enhancing the machine learning models used by the computing system 104 for anomaly detection and other functionalities.

Depending on the implementation, the environment 200 may display different types of usernames 210 depending on a status of the player. For example, the environment 200 may display a VIP username 210A or other graphical indication (e.g., a color, an icon, etc.) corresponding to a user profile associated with a celebrity participant, tournament winner, event participant/host, etc. Similarly, the environment may display a moderator username 210B and/or indicator for a user profile associated with an administrative moderator, a player moderator, a chat moderator, etc. Depending on the implementation, the VIP username 210A and/or moderator username may include a badge or other such icon indicative of the user profile status (e.g., a crown, a golden playing card, the tag “VIP” or “MOD”, respectively, etc.). Moreover, the environment may display the personal username 210C of the user in the environment 200 rendered for the corresponding user.

Depending on the implementation, VIP and/or moderator users may be announced and/or have results announced to other environments (e.g., other hands or rounds occurring simultaneously within the environment 200). Similarly, games with a VIP user may utilize a separate sorting system for the environment 200 to ensure that other players have the opportunity to interact and play with the VIP user.

In some implementations, the introduction of the VIP user provides better security and verification opportunities for other players participating in a round or hand in the environment 200. For example, players may fear cheating or unfair practices, and may further miss social elements of games when playing online. VIP profiles may serve to reassure players that games will be secure and fair, and may function as a deterrent, through expectations of improved security. To further improve such metrics, the user profiles tagged with a VIP or moderator status may have additional permissions, such as access to and/or ability to set up exclusive tournaments and/or streaming functionalities. In further implementations, all player profiles have such permissions, but may not be able to affect games, tournaments, and/or streaming set up by other profiles without a moderator or VIP status. In still further implementations, the VIP profiles may additionally provide an verified source of data, and data gathered from the VIP profile may be given a greater priority and/or trust level when determining whether malicious activity is detected.

FIG. 2B depicts an environment 200 similar to that of FIG. 2A, but in which the computing system 104 detects malicious packets and/or activity from a player. Depending on the implementation, the environment 200 may display a moderator window 250 including one or more detected instances of cheating. In some implementations, the moderator window 250 may include factors that the computing system 104 considered in generating the warning (e.g., indications of using third party cheating software, shared video characteristics with banned users, shared audio characteristics with banned users, shared internet traffic origin, shared financial account information, etc.). The moderator may interact with and/or access the determinations and/or data fueling the determinations, and may subsequently take action to add the user(s) to a suspended player list.

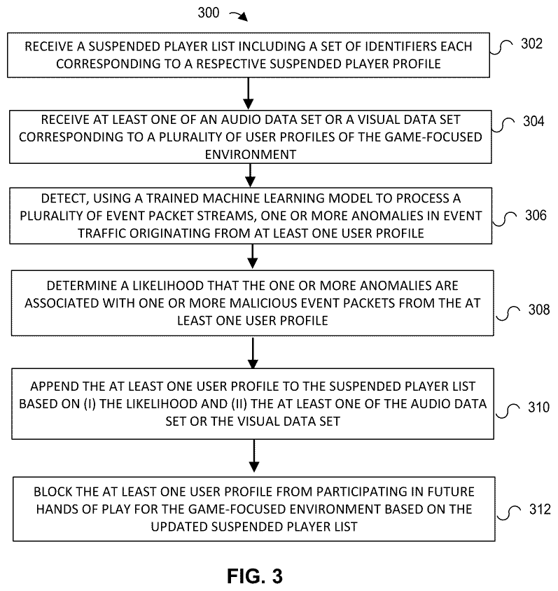

FIG. 3 is a flow diagram of an example method 300 for using a trained machine learning model to detect malicious event packets in a game-focused environment (e.g., the environment 200 of FIGS. 2A and 2B). The method 300 may be implemented as instructions stored on one or more non-transitory, computer-readable media (e.g., memory 144 of FIG. 1) and executed by one or more processors in one or more computing devices. For example, the method 300 may be implemented by the processor 142 of the computing system 104 in FIG. 1, when executing instructions of the gameplay module 150 and/or security module 152. It will be understood that additional, fewer, and/or alternate components may be used to implement the example method 300.

At block 302, the computing system 104 may receive a suspended player list including a set of identifiers, each corresponding to a respective suspended player profile.

At block 304, the computing system 104 may receive at least one of an audio data set or a visual data set corresponding to a plurality of user profiles of the game-focused environment. In some implementations, the audio data set and/or the visual data set corresponds to a moderator user profile, and the at least one of the audio data set or the visual data set includes an indication from the moderator user profile that the at least one user profile is associated with a corresponding suspended player profile on the suspended player list. For example, a moderator profile (e.g., an administrative moderator, a VIP moderator such as a celebrity, a player moderator, etc.) may determine that a user is potentially malicious, and may provide an audio or visual cue to the computing system 104 to indicate to the computing system 104 to search for potential malicious activity. As another example, the computing system 104 may detect the malicious packets and may provide an indication of such to the moderator profile, which may indicate to confirm the association with the suspended player profile. As yet another example, the computing system 104 may detect the malicious packets and may search audio/visual data associated with the moderator profile (e.g., taken during a game the moderator profile participated in and/or recorded) to determine whether the user profile in question is associated with a suspended player profile, etc.

At block 306, the computing system 104 may detect, using a trained machine learning model to process a plurality of event packet streams (e.g., from the plurality of user profiles), one or more anomalies in event traffic originating from at least one user profile of the plurality of user profiles. In some implementations, the one or more anomalies occur and/or are detected during a hand of play. For example, a user associated with the user profile may use tracking software and/or other such cheating software during a hand of play and/or the computing system 104 may detect such during the hand of play.

At block 308, the computing system 104 may determine a likelihood that the one or more anomalies are associated with one or more malicious event packets from the at least one user profile.

At block 310, the computing system 104 may append the at least one user profile to the suspended player list based on (i) the likelihood and (ii) the at least one of the audio data set or the visual data set. In some implementations, the computing system 104 appends the at least one user profile to the suspended player list responsive to the likelihood meeting or exceeding a threshold (e.g., a predetermined threshold, a variable threshold, etc.).

In further implementations, the computing system 104, as part of appending the user profile to the suspended player list, may determine that at least one of a first audio data set or a first visual data (e.g., corresponding to the user profile determined to meet or exceed the likelihood threshold) meets or exceeds a similarity threshold with a second audio data set or a second visual data set associated with a second user profile. As such, the computing system 104 may determine that the user associated with the user profile is also associated with other user profiles (e.g., side accounts, alternate accounts, etc.). The computing system 104 may then append both the user profile and any other user profiles determined to be associated with the user (e.g., the first user profile and the second user profile) to the suspended player list.

In still further implementations, the computing system 104, as part of appending the user profile to the suspended player list, may determine that a first audio data set or a first visual data set associated with the user profile meets or exceeds a similarity threshold with a second audio data set or a second audio data set associated with a player profile on the suspended player profile list. As such, the computing system 104 determines that the user profile corresponds to an already-suspended profile and may append the user profile in part based on the determination. In some such implementations, the computing system 104 additionally transmits the first audio data set or the first video data set to a verification device. The computing system 104 then appends the user profile to the suspended player list and/or blocks the player responsive to receiving a confirmation that the first audio data set and/or first video data set is sufficiently similar to the second audio and/or video data set. As such, an additional verification step (e.g., manual verification by a moderator profile, automatic verification by a separately stored and/or trained machine learning model, etc.) may be performed prior to preventing the user profile from accessing the environment.

In yet still further implementations, appending the user profile to the suspended player list may include receiving first financial account data associated with the first user profile and second financial account data associated with the suspended player profile. In such implementations, the computing system 104 may determine that the first financial account data matches the second financial account data as an additional verification step prior to appending the user profile to the suspended player list and/or blocking the user profile from accessing the environment.

At block 312, the computing system 104 may block the at least one user profile from participating in future hands of play for the game-focused environment based on the updated suspended player list. In further implementations, the computing system 104 may block the at least one user profile from observing future hands of play in addition to or in place of blocking the user profile from participating.

Artificial intelligence (AI) is a segment of computer science that focuses on the creation of models that can perform tasks with little to no human intervention. Artificial intelligence systems can utilize, for example, machine learning and computer vision. Machine learning, and its subsets, such as deep learning, focus on developing models that can infer outputs from data. The outputs can include, for example, predictions and/or classifications. Computer vision focuses on analyzing and interpreting images and videos. Artificial intelligence systems can include generative models that generate new content in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data and may be further updated or refined during their use based on additional feedback/inputs.

In some implementations, the computing system 104 may use one or more the machine learning models noted above to perform any one or more of the operations discussed herein in connection with machine learning.

In the context of the disclosed system and method for a celebrity-integrated and socially-enhanced online poker platform, let us consider how the environment 200, generated by the computing system 104, facilitates gameplay for multiple players across different games such as chess, Texas Hold 'Em poker, and Stud poker.

For a chess game within environment 200, a round or hand object may be generated by the computing system 104 to represent a single game of chess between two or more players. Each player's actions, such as moving a piece from one square to another, are captured as events within an event stream associated with the round object. The computing system 104 processes these event streams to update the game state in real-time, ensuring that each player's client device 102 displays the current board configuration. The association of the round object with the user profiles of the two players allows the system to track individual moves, game duration, and outcomes, which can be used for ranking purposes or to enhance the players'profiles with their game history.

In a Texas Hold 'Em poker game within environment 200, a hand object may be created for each hand of play involving multiple players. The event streams for this hand object capture a wide range of actions, including the dealing of community cards by the computing system 104, bets placed by players, folds, and the eventual reveal of hands to determine the winner. The computing system 104 processes these event streams to manage the flow of the game, from the initial dealing of hole cards to the conclusion of the hand. The association of the hand object with the user profiles of the participating players allows the system to personalize the experience, adjusting the gameplay based on the preferences and historical data of the players.

For a Stud poker game, the environment 200 similarly generates a hand object for each round of play, with event streams capturing the sequence of actions taken by players. Unlike Texas Hold 'Em, Stud poker involves a combination of face-up and face-down cards dealt to each player. The event streams accurately reflect the unique gameplay mechanics of Stud poker, including the dealing of both visible and hidden cards and the progression of betting rounds. The computing system 104 utilizes these event streams to ensure that the game adheres to the rules of Stud poker, providing an authentic and engaging experience for the players. The hand object's association with the user profiles enables the system to offer a tailored experience, recognizing each player's style and preferences.

In the context of the disclosed system and method for a celebrity-integrated and socially-enhanced online poker platform, the detection of malicious user behavior is a critical aspect of maintaining the integrity and fairness of the gaming environment 200. Malicious behavior may include the use of unauthorized third-party software to gain an unfair advantage, collusion between players, or any actions that violate the rules of the game. The computing system 104 employs a trained machine learning model to analyze event streams associated with round or hand objects to detect such behavior.

For example, in a Texas Hold 'Em poker game, a malicious user might attempt to use software that predicts the upcoming community cards based on an analysis of the current game state. This behavior could manifest in the event stream as unusually accurate bets or folds that correlate strongly with the outcomes of the hands. The computing system 104, by processing the event streams with its trained machine learning model, may detect anomalies indicative of such predictive behavior. The model may consider factors such as the timing of the actions, the size of the bets in relation to the hand strength, and patterns that deviate from expected gameplay.

Upon detecting a likelihood of malicious activity that meets or exceeds a predefined threshold, the computing system 104 may append the user profile associated with the suspicious behavior to a suspended player list. This action effectively blocks the user profile from participating in future hands of play within the environment 200. The decision to suspend a player is based on a comprehensive analysis of the event streams, potentially corroborated by additional data such as audio or visual data sets that may indicate collusion or other forms of cheating.

Notification of the suspension to other players in the session or round may be handled in various ways, depending on the design of the environment 200 and the preferences of the players. In some implementations, the computing system 104 may provide real-time (i.e., during a hand and/or session) notifications to players within the session, informing them of the suspension and the reason for it. This approach ensures transparency and reinforces the commitment to fair play. Alternatively, the system may opt for retroactive notification, where players are informed of the suspension and its context after the conclusion of the session or round. This method may be preferred in scenarios where immediate notification could disrupt the gameplay experience or when further investigation is required before making a final decision.

In either case, the computing system 104 may also implement measures to adjust the outcomes of the games affected by the malicious behavior, such as redistributing pots or adjusting player rankings, to ensure fairness for all participants. Player ratings and/or bets may be credited/debited retroactively upon detection of cheating or malicious play. The approach to detecting malicious behavior, suspending players, and notifying other participants is designed to maintain the integrity of the gaming environment while providing a positive and fair experience for all users.

In all these examples, the generation of round or hand objects by the computing system 104, and their association with event streams and user profiles, facilitates a dynamic and interactive gaming experience. This approach allows the system to cater to the nuances of different games while ensuring a personalized and socially-enhanced environment for all participants.

In the disclosed system and method for a celebrity-integrated and socially-enhanced online poker platform, the computing system 104 may employ multiple machine learning (ML) or artificial intelligence (AI) models that are trained separately for each game offered within the environment 200. This approach allows for the optimization of the models to the unique characteristics and strategies of each game, enhancing the system's ability to detect malicious behavior, predict outcomes, and provide a tailored gameplay experience.

For chess, an ML model may be trained on a vast dataset of historical chess games, including games played by grandmasters and amateurs alike. This model could analyze event streams for patterns that indicate strategic play, common openings, and endgame strategies. Additionally, it could be trained to detect anomalies that might suggest the use of unauthorized assistance, such as moves that consistently match those recommended by advanced chess engines.

In the case of Texas Hold 'Em poker, a separate ML model could be trained on gameplay data that includes betting patterns, bluffing strategies, and the statistical likelihood of winning given certain hand combinations. This model might also analyze the timing of player actions to detect signs of collusion or the use of predictive software. By understanding the nuances of Texas Hold 'Em, the model can more accurately identify legitimate skillful play versus potential cheating.

For Stud poker, another ML model may be trained with a focus on the unique aspects of this poker variant, such as the significance of visible cards and the strategies for betting in rounds where additional cards are revealed. This model may analyze event streams for patterns of play that deviate from expected strategies, given the visible information, to identify potential cheating or collusion.

In the context of the disclosed system and method for a celebrity-integrated and socially-enhanced online poker platform, it is recognized that certain legitimate play may occasionally exhibit patterns that could be mistakenly interpreted as indicative of cheating. This is particularly true in high-level play where strategic betting, bluffing, and decision-making can sometimes mimic the patterns that might be expected from a player utilizing unauthorized assistance or engaging in collusion. Given this complexity, the computing system 104 may employ nuanced approachs to analyzing event streams, incorporating second or third order variables for more sophisticated cheating detection.

For example, beyond the direct analysis of betting patterns and gameplay decisions, the computing system 104 may consider a variety of additional variables to distinguish between skilled play and potential cheating. For example, by analyzing the consistency of a player's strategy across multiple sessions or hands, the computing system 104 can identify whether unusual patterns of play are isolated incidents or part of a broader, potentially suspicious pattern of behavior. Further, the time it takes for players to make decisions can provide insights into their play style. Extremely fast reactions across a series of complex decisions may suggest the use of automated tools, while consistent delays followed by specific actions could indicate collusion or consultation with external sources. Furthermore, the computing system 104 may analyze communication channels within the environment 200, such as chat logs or audio streams, for patterns that suggest unauthorized information sharing between players. Additionally, patterns of play that consistently favor certain players over others in non-strategic ways may also be indicative of collusion. The analysis may extend to account-level variables, such as the use of the same IP address by multiple user profiles, frequent changes in player identifiers, or patterns of financial transactions that are consistent with known methods of cheating or money laundering. Moreover, the computing system 104 may compare observed gameplay patterns against a database of known cheating strategies and tools. This comparison can help identify matches or partial matches to known malicious behaviors. Still further, by comparing a player's performance against statistically expected outcomes given their hand and the game state, the computing system 104 can identify outliers. While skilled players will naturally outperform average expectations, consistently extreme deviations may warrant further investigation.

By incorporating these second and third order variables into its analysis of event streams, the computing system 104 can more accurately differentiate between legitimate high-level play and potential cheating. This multifaceted approach allows for a more nuanced understanding of player behavior, reducing the risk of false positives in cheating detection while ensuring that the environment 200 remains secure and fair for all participants.

Continuing with specific examples, for Pinochle, an ML model may be trained on the intricacies of melding, trick-taking, and scoring strategies unique to this card game. The model might analyze event streams for patterns of play that suggest a player has knowledge of cards they should not be aware of, indicating possible cheating. The ML model may also be trained to recognize patterns of play between partners that suggest unauthorized communication or collusion.

By training separate ML/AI models for each game, the computing system 104 can leverage the specific knowledge and strategies inherent to each game to enhance the detection of malicious behavior and improve the overall gameplay experience. These models can be continuously updated with new data to refine their accuracy and adapt to evolving gameplay strategies and cheating methods. This approach ensures that the environment 200 remains a fair and enjoyable platform for all users, regardless of the game they choose to play.

The following list of aspects reflects a variety of the embodiments explicitly contemplated by the present disclosure:

Aspect 1. A computer-implemented method for using a trained machine learning model to detect malicious event packets in a game-focused environment, comprising: receiving, by one or more processors, a suspended player list including a set of identifiers each corresponding to a respective suspended player profile; receiving, by the one or more processors, at least one of an audio data set or a visual data set corresponding to a plurality of user profiles of the game-focused environment; detecting, by the one or more processors and by using a trained machine learning model to process a plurality of event packet streams from the plurality of user profiles, one or more anomalies in event traffic originating from at least one user profile of the plurality of user profiles; determining, by the one or more processors, a likelihood that the one or more anomalies are associated with one or more malicious event packets from the at least one user profile; in response to the likelihood meeting or exceeding a threshold, appending, by the one or more processors, the at least one user profile to the suspended player list to generate an updated suspended player list based on (i) the likelihood and (ii) the at least one of the audio data set or the visual data set; and blocking, by the one or more processors, the at least one user profile from participating in future hands of play for the game-focused environment based on the updated suspended player list.

Aspect 2. The computer-implemented method of aspect 1, wherein the one or more anomalies in event traffic occur during a hand of play.

Aspect 3. The computer-implemented method of either one of aspect 1 or 2, wherein the at least one of the audio data set or the visual data set corresponds to a moderator user profile, and the at least one of the audio data set or the visual data set includes an indication from the moderator user profile that the at least one user profile is associated with a corresponding suspended player profile on the suspended player list.

Aspect 4. The computer-implemented method of any one of the preceding aspects, wherein the at least one user profile includes a first user profile, and the appending the at least one user profile to the suspended player list includes: determining, by the one or more processors, that at least one of a first audio data set or a first visual data set of the at least one of the audio data set or the visual data set meets or exceeds a similarity threshold with a second audio data set or a second visual data set associated with a second user profile; and appending, by the one or more processors, the first user profile and the second user profile to the suspended player list.

Aspect 5. The computer-implemented method of any one of the preceding aspects, wherein the at least one user profile includes a first user profile, and the appending the at least one user profile to the suspended player list includes: determining, by the one or more processors, that at least one of a first audio data set or a first visual data set of the at least one of the audio data set or the visual data set meets or exceeds a similarity threshold with a second audio data set or a second visual data set associated with a corresponding suspended player profile on the suspended player list.

Aspect 6. The computer-implemented method of aspect 5, further comprising: transmitting, by the one or more processors, the at least one of the first audio data set or the first video data set to a verification device; and receiving, by the one or more processors, a confirmation that the at least one of the first audio data set or the first video data set is similar to the second audio data set or the second visual data set; wherein the blocking is responsive to the receiving of the confirmation.

Aspect 7. The computer-implemented method of aspect 5, wherein the appending includes: receiving, by the one or more processors, first financial account data associated with the first user profile and second financial account data associated with the corresponding suspended player profile; and determining, by the one or more processors, that the first financial account data matches the second financial account data.

Aspect 8. A system configured for using a trained machine learning model to detect malicious event packets in a game-focused environment, comprising: a memory storing a set of computer-executable instructions; and one or more processors interfacing with the memory, and configured to execute the computer-executable instructions to cause the one or more processors to: receive a suspended player list including a set of identifiers each corresponding to a respective suspended player profile; receive at least one of an audio data set or a visual data set corresponding to a plurality of user profiles of the game-focused environment; detect, by using a trained machine learning model to process a plurality of event packet streams from the plurality of user profiles, one or more anomalies in event traffic originating from at least one user profile of the plurality of user profiles; determine a likelihood that the one or more anomalies are associated with one or more malicious event packets from the at least one user profile; in response to the likelihood meeting or exceeding a threshold, append the at least one user profile to the suspended player list to generate an updated suspended player list based on (i) the likelihood and (ii) the at least one of the audio data set or the visual data set; and block the at least one user profile from participating in future hands of play for the game-focused environment based on the updated suspended player list.

Aspect 9. The system of aspect 8, wherein the one or more anomalies in event traffic occur during a hand of play.

Aspect 10. The system of either one of aspect 8 or 9, wherein the at least one of the audio data set or the visual data set corresponds to a moderator user profile, and the at least one of the audio data set or the visual data set includes an indication from the moderator user profile that the at least one user profile is associated with a corresponding suspended player profile on the suspended player list.

Aspect 11. The system of any one of aspects 8-10, wherein the at least one user profile includes a first user profile, and appending the at least one user profile to the suspended player list includes: determining that at least one of a first audio data set or a first visual data set of the at least one of the audio data set or the visual data set meets or exceeds a similarity threshold with a second audio data set or a second visual data set associated with a second user profile; and appending the first user profile and the second user profile to the suspended player list.

Aspect 12. The system of any one of aspects 8-11, wherein the at least one user profile includes a first user profile, and appending the at least one user profile to the suspended player list includes: determining that at least one of a first audio data set or a first visual data set of the at least one of the audio data set or the visual data set meets or exceeds a similarity threshold with a second audio data set or a second visual data set associated with a corresponding suspended player profile on the suspended player list.

Aspect 13. The system of aspect 12, wherein the memory further stores instructions that, when executed by the one or more processors, cause the system to: transmit the at least one of the first audio data set or the first video data set to a verification device; and receive a confirmation that the at least one of the first audio data set or the first video data set is similar to the second audio data set or the second visual data set; wherein blocking the at least one user profile is responsive to the receiving of the confirmation.

Aspect 14. The system of aspect 12, wherein appending the at least one user profile to the suspended player list includes: receiving first financial account data associated with the first user profile and second financial account data associated with the corresponding suspended player profile; and determining that the first financial account data matches the second financial account data.

Aspect 15. A tangible, non-transitory computer-readable medium storing instructions for using a trained machine learning model to detect malicious event packets in a game-focused environment that, when executed by one or more processors of a computing device, cause the computing device to: receive a suspended player list including a set of identifiers each corresponding to a respective suspended player profile; receive at least one of an audio data set or a visual data set corresponding to a plurality of user profiles of the game-focused environment; detect, by using a trained machine learning model to process a plurality of event packet streams from the plurality of user profiles, one or more anomalies in event traffic originating from at least one user profile of the plurality of user profiles; determine a likelihood that the one or more anomalies are associated with one or more malicious event packets from the at least one user profile; in response to the likelihood meeting or exceeding a threshold, append the at least one user profile to the suspended player list to generate an updated suspended player list based on (i) the likelihood and (ii) the at least one of the audio data set or the visual data set; and block the at least one user profile from participating in future hands of play for the game-focused environment based on the updated suspended player list.

Aspect 16. The tangible, non-transitory computer-readable medium of aspect 15, wherein the one or more anomalies in event traffic occur during a hand of play.

Aspect 17. The tangible, non-transitory computer-readable medium of either one of aspect 15 or 16, wherein the at least one of the audio data set or the visual data set corresponds to a moderator user profile, and the at least one of the audio data set or the visual data set includes an indication from the moderator user profile that the at least one user profile is associated with a corresponding suspended player profile on the suspended player list.

Aspect 18. The tangible, non-transitory computer-readable medium of any one of aspects 15-17, wherein the at least one user profile includes a first user profile, and appending the at least one user profile to the suspended player list includes: determining that at least one of a first audio data set or a first visual data set of the at least one of the audio data set or the visual data set meets or exceeds a similarity threshold with a second audio data set or a second visual data set associated with a second user profile; and appending the first user profile and the second user profile to the suspended player list.

Aspect 19. The tangible, non-transitory computer-readable medium of any one of aspects 15-18, wherein the at least one user profile includes a first user profile, and appending the at least one user profile to the suspended player list includes: determining that at least one of a first audio data set or a first visual data set of the at least one of the audio data set or the visual data set meets or exceeds a similarity threshold with a second audio data set or a second visual data set associated with a corresponding suspended player profile on the suspended player list.

Aspect 20. The tangible, non-transitory computer-readable medium of aspect 19, wherein the non-transitory computer-readable medium further includes instructions that, when executed by the one or more processors, cause the computing device to: transmit the at least one of the first audio data set or the first video data set to a verification device; and receive a confirmation that the at least one of the first audio data set or the first video data set is similar to the second audio data set or the second visual data set; wherein blocking the at least one user profile is responsive to the receiving of the confirmation.

Although the foregoing text sets forth a detailed description of numerous different aspects and implementations of the invention, it should be understood that the scope of the patent is defined by the words of the claims set forth at the end of this patent. The detailed description is to be construed as exemplary only.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present) and B is true (or present), and both A and B are true (or present).

Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations.

Upon reading this disclosure, those of skill in the art will appreciate still additional alternative structural and functional designs through the principles described herein. Thus, while particular implementations and applications have been illustrated and described, it is to be understood that the disclosed implementations are not limited to the precise construction and components disclosed in the present disclosure. Various modifications, changes, and variations, which will be apparent to those skilled in the art, may be made in the arrangement, operation and details of the method and apparatus disclosed in the present disclosure without departing from the spirit and scope defined in the appended claims.

What is claimed is:

1. A computer-implemented method for using a trained machine learning model to detect malicious event packets in a game-focused environment, comprising:
receiving, by one or more processors, a suspended player list including a set of identifiers each corresponding to a respective suspended player profile;
receiving, by the one or more processors, at least one of an audio data set or a visual data set corresponding to a plurality of user profiles of the game-focused environment;
detecting, by the one or more processors and by using a trained machine learning model to process a plurality of event packet streams from the plurality of user profiles, one or more anomalies in event traffic originating from at least one user profile of the plurality of user profiles;
determining, by the one or more processors, a likelihood that the one or more anomalies are associated with one or more malicious event packets from the at least one user profile;
in response to the likelihood meeting or exceeding a threshold, appending, by the one or more processors, the at least one user profile to the suspended player list to generate an updated suspended player list based on (i) the likelihood and (ii) the at least one of the audio data set or the visual data set; and
blocking, by the one or more processors, the at least one user profile from participating in future hands of play for the game-focused environment based on the updated suspended player list.

2. The computer-implemented method of claim 1, wherein the one or more anomalies in event traffic occur during a hand of play.

3. The computer-implemented method of claim 1, wherein the at least one of the audio data set or the visual data set corresponds to a moderator user profile, and the at least one of the audio data set or the visual data set includes an indication from the moderator user profile that the at least one user profile is associated with a corresponding suspended player profile on the suspended player list.

4. The computer-implemented method of claim 1, wherein the at least one user profile includes a first user profile, and the appending the at least one user profile to the suspended player list includes:
determining, by the one or more processors, that at least one of a first audio data set or a first visual data set of the at least one of the audio data set or the visual data set meets or exceeds a similarity threshold with a second audio data set or a second visual data set associated with a second user profile; and
appending, by the one or more processors, the first user profile and the second user profile to the suspended player list.

5. The computer-implemented method of claim 1, wherein the at least one user profile includes a first user profile, and the appending the at least one user profile to the suspended player list includes:
determining, by the one or more processors, that at least one of a first audio data set or a first visual data set of the at least one of the audio data set or the visual data set meets or exceeds a similarity threshold with a second audio data set or a second visual data set associated with a corresponding suspended player profile on the suspended player list.

6. The computer-implemented method of claim 5, further comprising:
transmitting, by the one or more processors, the at least one of the first audio data set or the first video data set to a verification device; and
receiving, by the one or more processors, a confirmation that the at least one of the first audio data set or the first video data set is similar to the second audio data set or the second visual data set;
wherein the blocking is responsive to the receiving of the confirmation.

7. The computer-implemented method of claim 5, wherein the appending includes:
receiving, by the one or more processors, first financial account data associated with the first user profile and second financial account data associated with the corresponding suspended player profile; and
determining, by the one or more processors, that the first financial account data matches the second financial account data.

8. A system configured for using a trained machine learning model to detect malicious event packets in a game-focused environment, comprising:
a memory storing a set of computer-executable instructions; and
one or more processors interfacing with the memory, and configured to execute the computer-executable instructions to cause the one or more processors to:
receive a suspended player list including a set of identifiers each corresponding to a respective suspended player profile;
receive at least one of an audio data set or a visual data set corresponding to a plurality of user profiles of the game-focused environment;
detect, by using a trained machine learning model to process a plurality of event packet streams from the plurality of user profiles, one or more anomalies in event traffic originating from at least one user profile of the plurality of user profiles;
determine a likelihood that the one or more anomalies are associated with one or more malicious event packets from the at least one user profile;
in response to the likelihood meeting or exceeding a threshold, append the at least one user profile to the suspended player list to generate an updated suspended player list based on (i) the likelihood and (ii) the at least one of the audio data set or the visual data set; and
block the at least one user profile from participating in future hands of play for the game-focused environment based on the updated suspended player list.

9. The system of claim 8, wherein the one or more anomalies in event traffic occur during a hand of play.

10. The system of claim 8, wherein the at least one of the audio data set or the visual data set corresponds to a moderator user profile, and the at least one of the audio data set or the visual data set includes an indication from the moderator user profile that the at least one user profile is associated with a corresponding suspended player profile on the suspended player list.

11. The system of claim 8, wherein the at least one user profile includes a first user profile, and appending the at least one user profile to the suspended player list includes:
determining that at least one of a first audio data set or a first visual data set of the at least one of the audio data set or the visual data set meets or exceeds a similarity threshold with a second audio data set or a second visual data set associated with a second user profile; and
appending the first user profile and the second user profile to the suspended player list.

12. The system of claim 8, wherein the at least one user profile includes a first user profile, and appending the at least one user profile to the suspended player list includes:
determining that at least one of a first audio data set or a first visual data set of the at least one of the audio data set or the visual data set meets or exceeds a similarity threshold with a second audio data set or a second visual data set associated with a corresponding suspended player profile on the suspended player list.

13. The system of claim 12, wherein the memory further stores instructions that, when executed by the one or more processors, cause the system to:
transmit the at least one of the first audio data set or the first video data set to a verification device; and
receive a confirmation that the at least one of the first audio data set or the first video data set is similar to the second audio data set or the second visual data set;
wherein blocking the at least one user profile is responsive to the receiving of the confirmation.

14. The system of claim 12, wherein appending the at least one user profile to the suspended player list includes:
receiving first financial account data associated with the first user profile and second financial account data associated with the corresponding suspended player profile; and
determining that the first financial account data matches the second financial account data.

15. A tangible, non-transitory computer-readable medium storing instructions for using a trained machine learning model to detect malicious event packets in a game-focused environment that, when executed by one or more processors of a computing device, cause the computing device to:
receive a suspended player list including a set of identifiers each corresponding to a respective suspended player profile;
receive at least one of an audio data set or a visual data set corresponding to a plurality of user profiles of the game-focused environment;
detect, by using a trained machine learning model to process a plurality of event packet streams from the plurality of user profiles, one or more anomalies in event traffic originating from at least one user profile of the plurality of user profiles;
determine a likelihood that the one or more anomalies are associated with one or more malicious event packets from the at least one user profile;
in response to the likelihood meeting or exceeding a threshold, append the at least one user profile to the suspended player list to generate an updated suspended player list based on (i) the likelihood and (ii) the at least one of the audio data set or the visual data set; and
block the at least one user profile from participating in future hands of play for the game-focused environment based on the updated suspended player list.

16. The tangible, non-transitory computer-readable medium of claim 15, wherein the one or more anomalies in event traffic occur during a hand of play.

17. The tangible, non-transitory computer-readable medium of claim 15, wherein the at least one of the audio data set or the visual data set corresponds to a moderator user profile, and the at least one of the audio data set or the visual data set includes an indication from the moderator user profile that the at least one user profile is associated with a corresponding suspended player profile on the suspended player list.

18. The tangible, non-transitory computer-readable medium of claim 15, wherein the at least one user profile includes a first user profile, and appending the at least one user profile to the suspended player list includes:
determining that at least one of a first audio data set or a first visual data set of the at least one of the audio data set or the visual data set meets or exceeds a similarity threshold with a second audio data set or a second visual data set associated with a second user profile; and
appending the first user profile and the second user profile to the suspended player list.

19. The tangible, non-transitory computer-readable medium of claim 15, wherein the at least one user profile includes a first user profile, and appending the at least one user profile to the suspended player list includes:
determining that at least one of a first audio data set or a first visual data set of the at least one of the audio data set or the visual data set meets or exceeds a similarity threshold with a second audio data set or a second visual data set associated with a corresponding suspended player profile on the suspended player list.

20. The tangible, non-transitory computer-readable medium of claim 19, wherein the non-transitory computer-readable medium further includes instructions that, when executed by the one or more processors, cause the computing device to:
transmit the at least one of the first audio data set or the first video data set to a verification device; and
receive a confirmation that the at least one of the first audio data set or the first video data set is similar to the second audio data set or the second visual data set;
wherein blocking the at least one user profile is responsive to the receiving of the confirmation.
